(19) United States
(12) Patent Application Publication
(10) Pub. No.: US 2026/0140667 A1
(43) Pub. Date: May 21, 2026

(54) PERFORMING READ OPERATIONS DURING SUSPEND MODES

(71) Applicant: Micron Technology, Inc., Boise, ID (US)

(72) Inventors: Zeng Li, Shanghai (CN); Hui Ye, Shanghai (CN); Jun Jiang, Shanghai (CN)

(21) Appl. No.: 19/391,897

(22) Filed: Nov. 17, 2025

Related U.S. Application Data
(60) Provisional application No. 63/723,012, filed on Nov. 20, 2024.

(51) Int. Cl. G06F 3/06

(52) U.S. Cl. CPC G06F 3/0659; G06F 3/0611; G06F 3/0688

(57) ABSTRACT

Methods, systems, and devices for performing read operations during suspend modes are described. A memory system may receive one or more read commands while performing program operations and may store the read commands to respective queues associated with planes of a logical unit number (LUN) of the memory system. Once a threshold quantity of read commands have been received (e.g., stored to the queues), the memory system may suspend the ongoing program operations. The memory system may perform operations associated with the queued read commands when the program operations are suspended, and may resume the program operations after completion of the read operations.

### CROSS REFERENCE

The present Application for Patent claims priority to U.S. patent application Ser. No. 63/723,012 by Li et al., entitled “PERFORMING READ OPERATIONS DURING SUSPEND MODES,” filed Nov. 20, 2024, which is assigned to the assignee hereof, and which is expressly incorporated by reference in its entirety herein.

### TECHNICAL FIELD

The following relates to one or more systems for memory, including performing read operations during suspend modes.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports performing read operations during suspend modes in accordance with examples as disclosed herein.

FIG. 2 shows an example of a system that supports performing read operations during suspend modes in accordance with examples as disclosed herein.

FIG. 3 shows an example of a flowchart that supports performing read operations during suspend modes in accordance with examples as disclosed herein.

FIG. 4 shows a block diagram of a memory system that supports performing read operations during suspend modes in accordance with examples as disclosed herein.

FIG. 5 shows a flowchart illustrating a method or methods that support performing read operations during suspend modes in accordance with examples as disclosed herein.

### DETAILED DESCRIPTION

Some memory systems may be configured to suspend one or more ongoing program operations (e.g., a write operation) to perform operations associated with incoming read commands. While this may result in a faster response time for performing read operations associated with the read commands, suspending program operations (e.g., a program suspend) may add latency to the respective program operation(s). For example, a program suspend may incur a quantity of time (e.g., approximately 150 microseconds) from the time an internal command (e.g., a program suspend command) is issued and when the memory system suspends operation of the associated program operation in response to the time the memory system resumes and ultimately completes the program operation. In some examples, the memory system may incur additional time when resuming the program operations due to various other memory system factors. For example, in the case that the memory system may perform multiple read and write operations within a short duration, the memory system may suspend multiple program operations, which may negatively affect the efficiency (e.g., bus efficiency) and overall performance of the memory system. This additional time decreases performance and impacts user experience.

To increase memory system efficiency and reliability, the memory system may implement one or more queues at a plane level to manage received access commands and allow the memory system to perform access commands (e.g., multiple access commands) during a single memory system suspension. For example, the memory system may receive one or more read commands while performing program operations (e.g., while program operations are ongoing), and may store the read commands at queues of the memory system. Once a threshold quantity of read commands have been stored at one or more of the queues, the memory system may suspend the ongoing program operations (e.g., initiating a suspend mode). The memory system may perform operations associated with the queued read commands during the suspend mode, and may resume the program operations after completion of the read operations. By implementing one or more queues to store access commands during ongoing program operations, the memory system may reduce the latency incurred by performing multiple read operations during a single program suspension. For example, implementing one or more queues at the memory system to manage memory system suspension operations may increase efficiency of the memory system (e.g., busses thereof), which may in turn increase the bandwidth of the memory system in mixed-access operation workloads.

In addition to applicability in memory systems as described herein, performing read operations during suspend modes may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems as described herein, performing read operations during suspend modes may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by reducing overall operation time used in otherwise unregulated program suspend operations, which may extend the life of electronic devices and thereby reducing electronic waste, among other benefits.

Features of the disclosure are illustrated and described in the context of systems, devices, and circuits. Features of the disclosure are further illustrated and described in the context of process flows and flowcharts.

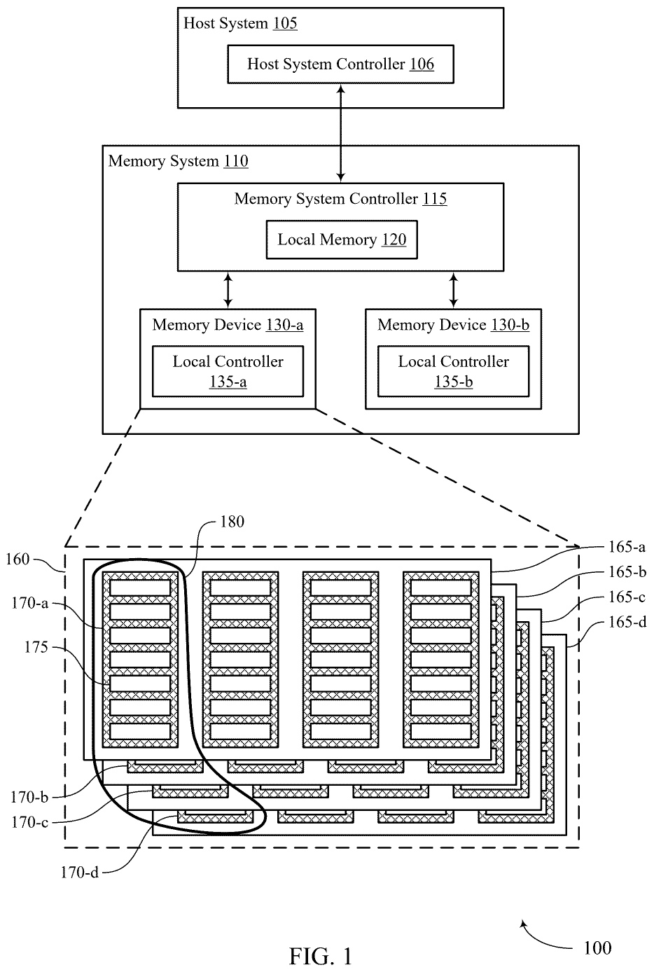

FIG. 1 shows an example of a system 100 that supports performing read operations during suspend modes in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The memory system 110 may be configured to suspend an ongoing program operation (e.g., a write operation) to perform operations associated with incoming read commands. While this may result in a faster response time for performing read operations associated with the read commands, suspending program operations (e.g., a program suspend) may add additional latency to the respective program operation(s). For example, a program suspend may incur a quantity of time (e.g., approximately 150 microseconds) from the time an internal command (e.g., a program suspend command) is issued and when the memory system 110 suspends operation of the associated program operation in response, to the time the memory system 110 resumes and ultimately completes the program operation. In some examples, the memory system 110 may incur additional time when resuming the program operations due to various other memory system factors. For example, in the case that the memory system 110 may perform multiple read and write operations within a short duration, the memory system 110 may suspend multiple program operations, which may negatively affect the efficiency (e.g., bus efficiency) and overall performance of the memory system 110.

To increase efficiency and reliability of the memory system 110, the memory system may implement one or more queues at a level of the planes 165 of the memory system 110 to manage received access commands and allow the memory system 110 to perform access commands (e.g., multiple access commands) during a single memory system suspension. For example, the memory system 110 may receive one or more read commands while performing program operations (e.g., while program operations are ongoing), and may store the read commands at queues of the memory system 110 (e.g., a queue at each of the planes 165). Once a threshold quantity of read commands have been stored at one or more of the queues, the memory system 110 may suspend the ongoing program operations (e.g., to initiate a suspend mode).

The memory system 110 may perform operations associated with the queued read commands during the suspend mode, and may resume the program operations after completion of the read operations. By implementing queues to store access commands during ongoing program operations, the memory system 110 may reduce the latency incurred by performing multiple read operations during a single program suspension. For example, implementing one or more queues at the planes 165 of the memory system 110 to manage memory system suspension operations may increase efficiency of the memory system 110 (e.g., or busses thereof), which may in turn increase the bandwidth of the memory system 110 in future mixed-access operation workloads.

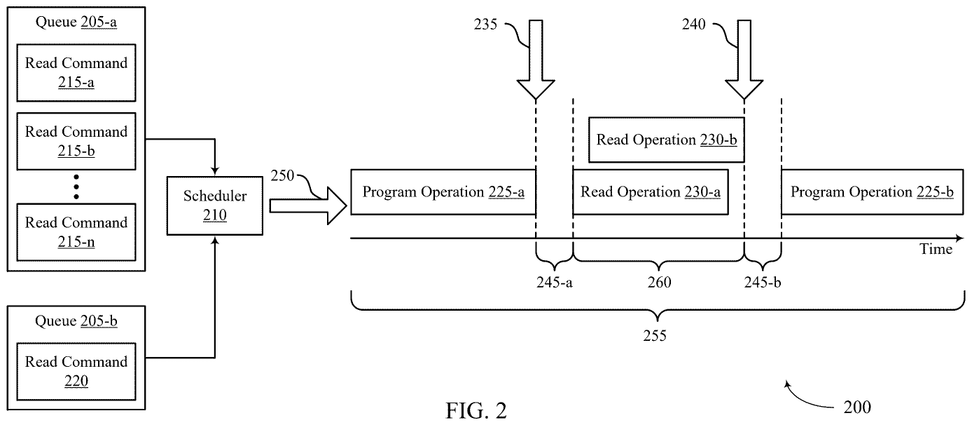

FIG. 2 shows an example of a system 200 that supports performing read operations during suspend modes in accordance with examples as disclosed herein. The system 200 may be an example of or implement aspects of a system 100 as described with reference to FIG. 1, or aspects thereof. The system 200 may include one or more queues 205 and a scheduler 210, which may be examples of components included in a memory system 110 and in communication with other systems as described with reference to FIG. 1. For example, the queues 205, the scheduler 210, or a combination thereof may be located in a memory system or a controller thereof, and may be coupled with a host system. The system 200 may include a timeline of operations 255 that may be performed by the memory system using the scheduler 210, the queues 205, and other components.

A memory system may perform one or more program operations 225. The program operation 225 may be an example of an operation associated with an application (e.g., a user application) and may be initiated by (e.g., associated with) an access command received from a host system. For example, the memory system may receive a write command and may perform the program operation 225 (or a portion of the program operation 225) associated with the write command. In some examples, the memory system may be configured to suspend the program operation 225 (e.g., an ongoing write operation or other associated operation) to perform operations associated with incoming read commands. For example, the memory system may receive a read command 215-a while performing the program operation 225, and may transmit an internal program suspend command 235 to one or more components of the memory system. In response to the program suspend command 235, the memory system (e.g., or components thereof) may suspend (e.g., pause) the program operation 225 to perform a read operation associated with the read command 215-a. After completion of the read operation, the memory system may transmit an internal resume command 240 to resume and, in some instances, complete the program operation 225.

While the suspension of the program operation 225 and performance of the read command 215-a may result in a faster response time for executing the read command 215-a, the suspension of the program operation 225 (e.g., initiated by a program suspend command 235) may be associated with a relatively long operating time. Suspending the program operation 225, performing a read operation associated with the received read command 215, and resuming the program operation 225 may add additional latency to the operations performed by the memory system, which may affect its overall efficiency and performance. For example, the memory system may incur approximately 150 microseconds in transmitting the program suspend command 235 and waiting to begin the read operations, and may incur approximately 50 microseconds in transmitting the internal resume command 240 and waiting to resume the program operation 225.

In some examples, the memory system may also incur additional time to resume the program operation 225 due to various other memory system factors. In the case that the memory system may perform multiple read and write (e.g., program) operations within a short duration, the memory system may perform multiple program suspensions, which may negatively affect the efficiency of the memory system (e.g., efficiency of busses of the memory system) and its overall performance.

To increase memory system efficiency and reliability, one or more queues may be implemented to manage the received read commands (e.g., the read commands 215, the read command 220) such that the memory system may perform read operations associated with the read commands during a single memory system suspension. In some instances, the memory system may implement one or more queues at a plane-level of the memory system. For example, each plane (e.g., a plane of a LUN) may be associated with a respective queue (or a respective portion of a queue) configured to temporarily store received read commands.

In some examples, the memory system may include the queues 205. Each of the queues 205 may be associated with a respective plane of the memory system, where each plane may be an example of a plane 165 as described with reference to FIG. 1. For example, the queue 205-a may be associated with a first plane of the memory system, and the queue 205-b may be associated with a second plane of the memory system. In some examples, each LUN of the memory system may be associated with one or more planes and thus one or more of the queues 205. For example, a single LUN may include both the first plane and the second plane, and thus may include the queue 205-a and the queue 205-b. Each LUN may include a same quantity of planes and queues 205 (e.g., there may be a 1:1 correspondence between planes and queues 205 at each LUN). In other examples, a LUN may be associated with a single queue 205 or any quantity of queues 205.

The queues 205 may be configured to store access commands (e.g., read commands) transmitted by the host system and received by the memory system. The memory system may receive read commands (e.g., read commands 215, a read command 220) and may temporarily store the read commands to the queues 205. For example, the memory system may receive one or more read commands 215 (e.g., read commands 215-a, 215-b, through 215-n) associated with a first plane of a LUN and a read command 220 associated with a second plane of the LUN. In the case that the memory system may not actively be performing the program operation 225 (e.g., the memory system is available to perform read commands), the memory system may perform read operations associated with the received read commands 215 and the received read command 220. In the case that the memory system may be performing the program operation 225 when the read commands are received (e.g., the program operation 225 is ongoing), the memory system may store the received read commands 215 associated with the first plane of the LUN in the queue 205-a and may store the received read commands 220 associated with the second plane of the LUN in the queue 205-b.

In some examples, the memory system (e.g., a controller or component thereof) may be enabled to perform one or more read operations associated with different planes of a logical unit (LUN) the memory system at once. For example, in the case that incoming access commands may be associated with different planes of a LUN of the memory system, the memory system may perform multiple access operations associated with different planes of the LUN at a same time. While performing multiple access operations at once may decrease overall time used by the memory system in performing access operations, previous techniques may not allow the memory system to perform such simultaneous access operations during a program suspend operation, and thus the overall operation time of the memory system may be negatively impacted by unregulated program suspensions.

The queues 205 may store the received read commands until a threshold quantity of read commands has been stored at one or more of the queues 205. In the case the memory system may store the read commands 215 to the queue 205-a and may store the read command 220 to the queue 205-b in response to an ongoing program operation (e.g., the program operation 225), the queues 205 may continue to store the read commands until a threshold has been satisfied. In some examples, the threshold may be an example of a threshold quantity of read commands received during a duration (e.g., a ratio of received read commands to time, a threshold ratio). In other examples, the threshold may be an example of a threshold quantity of read commands stored to one or more of the queues 205. For example, the threshold may be a threshold quantity of read commands stored to one of the queues 205 while, in other examples, the threshold may be a threshold quantity of queues that store one or more read commands.

The queues 205 may continue to store the read commands and the memory system may continue receiving read commands and storing read commands to the queues 205 while the threshold is not satisfied (e.g., until the threshold is satisfied). The memory system, or a controller of the memory system, may determine whether the threshold is satisfied. The memory system may continue to store read commands to the queues 205 if the controller determines that the threshold is not satisfied, and may suspend the ongoing program operation 225 if the controller determines that the threshold is satisfied.

Once the threshold has been satisfied, the memory system may suspend the ongoing program operation 225. In some examples, the memory system may determine a quantity of read commands received over a duration to satisfy the threshold ratio (e.g., a ratio of received read commands to time). In some other examples, the memory system may determine a quantity of read commands stored to one or more of the queues 205 to satisfy the threshold quantity of read commands. In response to determining the threshold (e.g., the threshold ratio, the threshold quantity of read commands) is satisfied, the memory system may suspend the program operation 225. For example, the memory system may issue the internal program suspend command 235 to one or more components of the memory system to initiate a suspension (e.g., a pause) of the program operation 225-a, as illustrated in the timeline of operations 255. In some examples, the memory system may wait a duration 245-a after issuing the program suspend command 235 to pause the program operation 225-a and prepare to perform read operations 230.

After suspending the program operation 225-a, the memory system may perform one or more read operations 230. For example, in response to determining the threshold (e.g., the threshold ratio, the threshold quantity of read commands) is satisfied and issuing the program suspend command 235, the scheduler 210 of the memory system may group one or more of the read commands stored to the queues 205 into a single read command 250. The scheduler 210 may group one or more read commands associated with different planes of a single LUN. For example, the scheduler 210 may group the read command 215-a stored to the queue 205-a of the first plane of the LUN and the read command 220 stored to the queue 205-b of the second plane of the LUN into the single read command 250. In some examples, the scheduler 210 may group a single stored (e.g., available) read command for each plane. After generating the single read command 250, the memory system may issue the single read command 250 (e.g., instead of issuing multiple, separate, read commands). In some examples, the scheduler 210 may be included in or controlled by a controller of the memory system.

In response to generating the single read command 250, the memory system may perform one or more read operations 230, as illustrated by the timeline of operations 255. After the duration 245-a and in response to generating the single read command 250, the memory system may perform read operations 230 associated with each of the grouped read commands of the single read command 250 (e.g., may perform read operations 230 associated with different planes of a same LUN). For example, the memory system may perform a read operation 230-a associated with the read command 215-a of the single read command 250, and may perform a read operation 230-b associated with the read command 220 of the single read command 250. By grouping the stored read commands into the single read command 250, the memory system may perform the associated read operations 230 in a single read duration 260 (e.g., during a single memory system suspension). In some examples, the memory system may perform the read operations 230 at least partially overlapping in time, while in other examples the memory system may perform the read operations 230 simultaneously (e.g., at the same time).

The memory system may resume the program operation 225. For example, after performing the read operations 230, the memory system may resume the program operation 225. The memory system may issue the internal resume command 240 to one or more components of the memory system to initiate a resumption of the program operation 225, as illustrated in the timeline of operations 255. For example, the program operation 225-b may be a continuation of the program operation 225-a, and may be associated with a same command (e.g., a write command). In some examples, the memory system may wait a duration 245-b after issuing the internal resume command 240 to resume the program operation 225-b (e.g., prepare to resume the program operation 225-b).

Implementing queues to store read commands during ongoing program operations 225 and enabling the memory system to perform multiple read operations during a single program suspension, the operation time at the memory system may be reduced. By storing received read commands in the queues 205 and performing the single read command 250 during a single suspension (e.g., instead of separate commands at different times), operation time of the memory system may be increased by the durations 245 of a single suspension rather than durations 245 associated with each of the read operations 230 (e.g., separate read commands). For example, in the case that the duration 245-a may be approximately 150 microseconds and the duration 245-b may be approximately 50 microseconds, performing read operations 230 associated with the single read command 250 during the single read duration 260 may result in added operation time of approximately 200 microseconds, which may be much less time relative to performing multiple suspend operations prior to performing the respective read operations that may each add 200 microseconds to the overall operating time. Implementing the queues 205 at the memory system to manage memory system suspension operations may increase efficiency of the memory system, which may in turn may increase the bandwidth of the memory system in mixed-access operation workloads (e.g., in the case of multiple consecutive write and read operations).

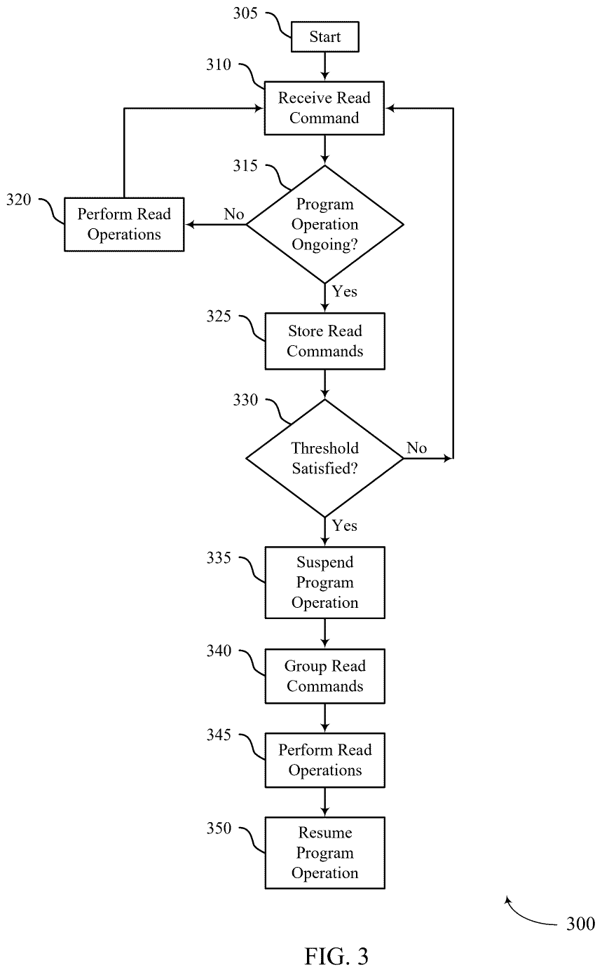

FIG. 3 shows an example of a flowchart 300 that supports performing read operations during suspend modes in accordance with examples as disclosed herein. The operations of flowchart 300 may be performed by a memory system or one or more controllers associated with the memory system as described herein. For example, the operations of flowchart 300 may be performed by a memory system 110, as described with reference to FIG. 1.

At 305, the memory system may begin processes associated with performing read operations during suspend modes in accordance with examples as disclosed herein. At 310, the memory system may receive one or more read commands. In some examples, the memory system may receive the one or more read commands from a host system or another external system.

At 315, the memory system may determine whether a program operation is ongoing. For example, in response to receiving the one or more read commands, the memory system (e.g., or a controller thereof) may determine whether the memory system is performing a program operation. In the case that the memory system (e.g., the controller) determines that a program operation is not ongoing (e.g., the memory system is not performing a program operation), the memory system may perform the one or more read operations at 320. In some examples, the memory system may receive one or more other read commands (e.g., at 310) after performing the received read commands at 320. In the case that the memory system (e.g., the controller) determines that a program operation is ongoing (e.g., the memory system is performing a program operation), the memory system may store the read commands at 325.

At 325, the memory system may store the received read commands. For example, in response to determining that the memory system is performing a program operation, the memory system may store the read commands in one or more queues of the memory system (e.g., during the program operation). In some examples, each of the queues may be associated with a separate plane of the memory system. In some examples, one or more of the queues may be associated with a LUN of the memory system.

In some examples, the memory system may receive a write command associated with the program operations prior to receiving the one or more read commands. In the case that the memory system receives the write command, the memory system may store the one or more read commands to the one or more queues in response to receiving the write command and performing program operations associated with the write command.

At 330, the memory system (e.g., the controller) may determine whether one or more thresholds are satisfied. In some examples, the threshold may be associated with a threshold quantity of read commands stored to one or more queues of the memory system. For example, the threshold may be a threshold quantity of read commands stored to one of the queues while, in other examples, the threshold may be a threshold quantity of queues that store one or more read commands. For example, in response to storing the read commands to the queues of the memory system, the memory system (e.g., the controller) may determine that a quantity of read commands stored to one or more of the queues of the memory system does not satisfy a threshold quantity of commands. In response to determining that the quantity of stored read commands does not satisfy the threshold quantity of commands, the memory system may receive one or more other read commands (e.g., at 310) and store the new read commands at 325. In other examples, in response to storing the read commands to the queues of the memory system, the memory system (e.g., the controller) may determine that a quantity of read commands stored to one or more of the queues of the memory system satisfies the threshold quantity of commands. In response to determining that the quantity of stored read commands satisfies the threshold quantity of commands, the memory system may suspend the program operation at 335.

In some examples, the threshold may be associated with a quantity of read commands received during a duration (e.g., a ratio of received read commands to time). For example, in response to storing the read commands to the queues of the memory system, the memory system (e.g., the controller) may determine that the quantity of read commands stored to the queues during the duration does not satisfy the threshold ratio. In response to determining that the quantity of read commands stored during the duration does not satisfy the threshold ratio, the memory system may receive one or more other read commands (e.g., at 310) and store the new read commands at 325. In other examples, in response to storing the read commands to the queues of the memory system, the memory system (e.g., the controller) may determine that the quantity of read commands stored to one or more of the queues during the duration satisfies the threshold ratio. In response to determining that the quantity of read commands stored during the duration satisfies the threshold ratio, the memory system may suspend the program operation at 335.

At 335, the memory system may suspend the program operations. For example, in response to the stored read commands satisfying the threshold, the memory system may suspend the program operations at 335. In some examples, the memory system may issue an internal command to suspend the program operation and a controller, or other component of the memory system, may suspend the program operation in response to the internal command.

At 340, the memory system may group one or more of the stored read commands. For example, in response to suspending the program operation, the memory system (e.g., or a scheduler or controller thereof) may group a read command from each queue of the one or more queues of the memory system into a single read command. The memory system may issue the single read command.

At 345, the memory system may perform one or more read operations associated with the stored read commands. For example, in response to suspending the program operation, grouping the read operations, and issuing the single read command, the memory system may perform the single read command (e.g., one or more read operations associated with the grouped read commands) during the suspension. In some examples, the memory system may perform read operations associated with read commands stored to each queue of the one or more queues of the memory system. For example, the memory system may perform read operations associated with separate planes of the memory system. The memory system may perform the one or more read operations after a duration from issuing the internal command to suspend the program operation. In some examples, in performing read operations associated with the single read command, the memory system may perform a first read operation associated with a read command stored to a first queue of the one or more queues associated with a first plane of the memory system during a first duration, and may perform a second read operation associated with a read command stored to a second queue of the one or more queues associated with a second plane of the memory system during a second duration. In some examples, performing the first read operation during the first duration and performing the second read operation during the second duration may at least partially overlap in time.

At 350, the memory system may resume the program operation. For example, after performing the read operations stored to one or more of the queues, the memory system may resume the program operation. In some examples, the memory system may issue an internal command to resume the program operation and a controller, or other component of the memory system, may resume the program operation in response to the internal command. In some examples, the memory system may resume the program operation after a duration from issuing the internal command to resume the program operation. In some examples, the program operation and the resumed program operation may be associated with the write command.

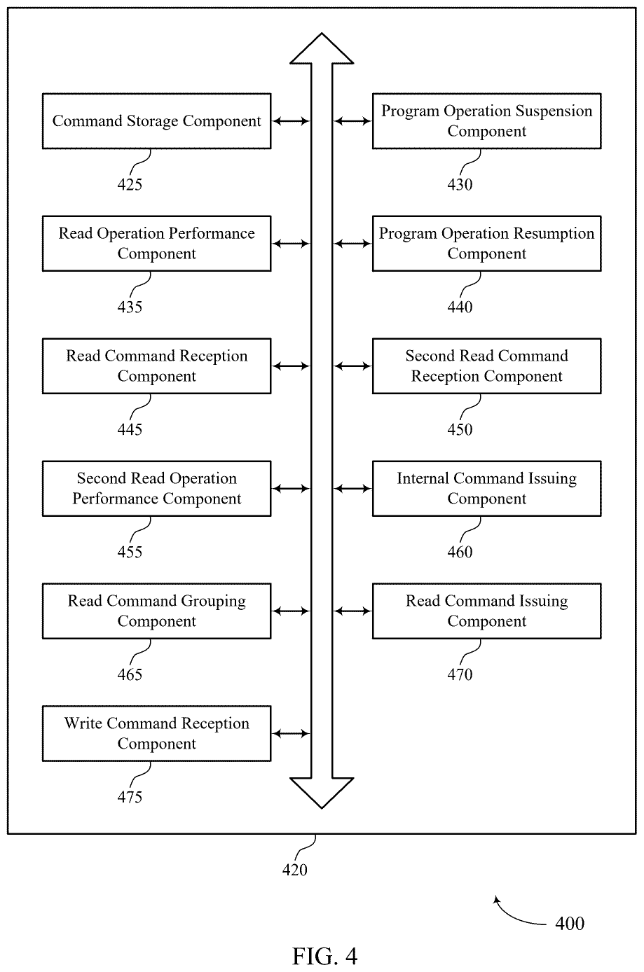

FIG. 4 shows a block diagram 400 of a memory system 420 that supports performing read operations during suspend modes in accordance with examples as disclosed herein. The memory system 420 may be an example of aspects of a memory system as described with reference to FIGS. 1 through 3. The memory system 420, or various components thereof, may be an example of means for performing various aspects of performing read operations during suspend modes as described herein. For example, the memory system 420 may include a command storage component 425, a program operation suspension component 430, a read operation performance component 435, a program operation resumption component 440, a read command reception component 445, a second read command reception component 450, a second read operation performance component 455, an internal command issuing component 460, a read command grouping component 465, a read command issuing component 470, a write command reception component 475, or any combination thereof. Each of these components, or components of subcomponents thereof (e.g., one or more processors, one or more memories), may communicate, directly or indirectly, with one another (e.g., via one or more buses).

The command storage component 425 may be configured as or otherwise support a means for storing, during a program operation, one or more read commands to one or more queues of a memory system, where each queue of the one or more queues is associated with a respective plane of the memory system. The program operation suspension component 430 may be configured as or otherwise support a means for suspending the program operation based at least in part on a quantity of read commands stored to a first queue of the one or more queues satisfying a threshold quantity. The read operation performance component 435 may be configured as or otherwise support a means for performing, while the program operation is suspended, one or more read operations corresponding to the read commands stored to the one or more queues based at least in part on suspending the program operation.

In some examples, the program operation resumption component 440 may be configured as or otherwise support a means for resuming the program operation after performing read operations corresponding to each of the read commands stored to the one or more queues.

In some examples, the program operation resumption component 440 may be configured as or otherwise support a means for resuming the program operation after performing the one or more read operations and based at least in part on the quantity of read commands stored to the first queue of the one or more queues failing to satisfy the threshold quantity.

In some examples, the read command reception component 445 may be configured as or otherwise support a means for receiving the one or more read commands within a threshold duration, where suspending the program operation is based at least in part on receiving the one or more read commands within the threshold duration.

In some examples, the second read command reception component 450 may be configured as or otherwise support a means for receiving one or more second read commands before the program operation is initiated. In some examples, the second read operation performance component 455 may be configured as or otherwise support a means for performing, before the program operation is initiated, the one or more second read commands based at least in part on receiving the one or more second read commands.

In some examples, each queue of the one or more queues are associated with a first logical unit number (LUN) of the memory system.

In some examples, the read command grouping component 465 may be configured as or otherwise support a means for grouping a read command from each queue of the one or more queues into a single read command. In some examples, the read command issuing component 470 may be configured as or otherwise support a means for issuing the single read command based at least in part on grouping the read command from each queue, where performing the one or more read operations corresponding to the read command stored to each queue is based at least in part on issuing the single read command.

In some examples, to support performing the one or more read operations, the read operation performance component 435 may be configured as or otherwise support a means for performing a read operation corresponding to a read command stored to each queue of the one or more queues, where each read operation is associated with a different plane of the memory system.

In some examples, the read command reception component 445 may be configured as or otherwise support a means for receiving the one or more read commands during the program operation, where storing the one or more read commands is based at least in part on receiving the one or more read commands.

In some examples, the internal command issuing component 460 may be configured as or otherwise support a means for issuing an internal command to suspend the program operation based at least in part on the quantity of read commands stored to the first queue of the one or more queues satisfying the threshold quantity, where suspending the program operation is based at least in part on issuing the internal command.

In some examples, the one or more read operations are performed after a duration from issuing the internal command to suspend the program operation.

In some examples, the internal command issuing component 460 may be configured as or otherwise support a means for issuing an internal command to resume the program operation. In some examples, the program operation resumption component 440 may be configured as or otherwise support a means for resuming the program operation based at least in part on issuing the internal command.

In some examples, the program operation is resumed after a duration from issuing the internal command to resume the program operation.

In some examples, the write command reception component 475 may be configured as or otherwise support a means for receiving a write command, where storing the one or more read commands to the one or more queues of the memory system is based at least in part on receiving the write command, and where the program operation and the resumed program operation are associated with the write command.

In some examples, to support performing the one or more read operations, the read operation performance component 435 may be configured as or otherwise support a means for performing, during a first duration, a first read operation corresponding to a first read command stored to the first queue of the one or more queues associated with a first plane of the memory system. In some examples, to support performing the one or more read operations, the read operation performance component 435 may be configured as or otherwise support a means for performing, during a second duration, a second read operation corresponding to a second read command stored to a second queue of the one or more queues associated with a second plane of the memory system, where performing the first read operation during the first duration and performing the second read operation during the second duration at least partially overlap in time.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

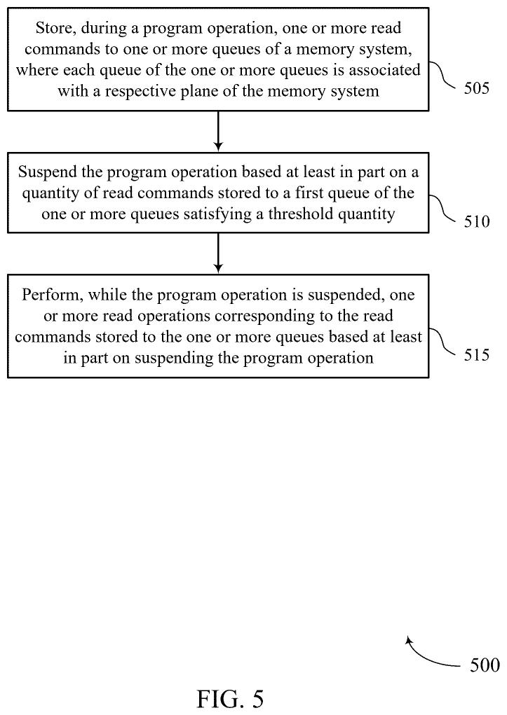

FIG. 5 shows a flowchart illustrating a method 500 that supports performing read operations during suspend modes in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include storing, during a program operation, one or more read commands to one or more queues of a memory system, where each queue of the one or more queues is associated with a respective plane of the memory system. In some examples, aspects of the operations of 505 may be performed by a command storage component 425 as described with reference to FIG. 4.

At 510, the method may include suspending the program operation based at least in part on a quantity of read commands stored to a first queue of the one or more queues satisfying a threshold quantity. In some examples, aspects of the operations of 510 may be performed by a program operation suspension component 430 as described with reference to FIG. 4.

At 515, the method may include performing, while the program operation is suspended, one or more read operations corresponding to the read commands stored to the one or more queues based at least in part on suspending the program operation. In some examples, aspects of the operations of 515 may be performed by a read operation performance component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for storing, during a program operation, one or more read commands to one or more queues of a memory system, where each queue of the one or more queues is associated with a respective plane of the memory system; suspending the program operation based at least in part on a quantity of read commands stored to a first queue of the one or more queues satisfying a threshold quantity; and performing, while the program operation is suspended, one or more read operations corresponding to the read commands stored to the one or more queues based at least in part on suspending the program operation.

Aspect 2: The method, apparatus, or non-transitory computer-readable medium of aspect 1, further including operations, features, circuitry, logic, means, or instructions, or any combination thereof for resuming the program operation after performing read operations corresponding to each of the read commands stored to the one or more queues.

Aspect 3: The method, apparatus, or non-transitory computer-readable medium of any of aspects 1 through 2, further including operations, features, circuitry, logic, means, or instructions, or any combination thereof for resuming the program operation after performing the one or more read operations and based at least in part on the quantity of read commands stored to the first queue of the one or more queues failing to satisfy the threshold quantity.

Aspect 4: The method, apparatus, or non-transitory computer-readable medium of any of aspects 1 through 3, further including operations, features, circuitry, logic, means, or instructions, or any combination thereof for receiving the one or more read commands within a threshold duration, where suspending the program operation is based at least in part on receiving the one or more read commands within the threshold duration.

Aspect 5: The method, apparatus, or non-transitory computer-readable medium of any of aspects 1 through 4, further including operations, features, circuitry, logic, means, or instructions, or any combination thereof for receiving one or more second read commands before the program operation is initiated and performing, before the program operation is initiated, the one or more second read commands based at least in part on receiving the one or more second read commands.

Aspect 6: The method, apparatus, or non-transitory computer-readable medium of any of aspects 1 through 5, where each queue of the one or more queues are associated with a first LUN of the memory system.

Aspect 7: The method, apparatus, or non-transitory computer-readable medium of aspect 6, further including operations, features, circuitry, logic, means, or instructions, or any combination thereof for grouping a read command from each queue of the one or more queues into a single read command and issuing the single read command based at least in part on grouping the read command from each queue, where performing the one or more read operations corresponding to the read command stored to each queue is based at least in part on issuing the single read command.

Aspect 8: The method, apparatus, or non-transitory computer-readable medium of any of aspects 1 through 7, where performing the one or more read operations includes operations, features, circuitry, logic, means, or instructions, or any combination thereof for performing a read operation corresponding to a read command stored to each queue of the one or more queues, where each read operation is associated with a different plane of the memory system.

Aspect 9: The method, apparatus, or non-transitory computer-readable medium of any of aspects 1 through 8, further including operations, features, circuitry, logic, means, or instructions, or any combination thereof for receiving the one or more read commands during the program operation, where storing the one or more read commands is based at least in part on receiving the one or more read commands.

Aspect 10: The method, apparatus, or non-transitory computer-readable medium of any of aspects 1 through 9, further including operations, features, circuitry, logic, means, or instructions, or any combination thereof for issuing an internal command to suspend the program operation based at least in part on the quantity of read commands stored to the first queue of the one or more queues satisfying the threshold quantity, where suspending the program operation is based at least in part on issuing the internal command.

Aspect 11: The method, apparatus, or non-transitory computer-readable medium of aspect 10, where the one or more read operations are performed after a duration from issuing the internal command to suspend the program operation.

Aspect 12: The method, apparatus, or non-transitory computer-readable medium of any of aspects 1 through 11, further including operations, features, circuitry, logic, means, or instructions, or any combination thereof for issuing an internal command to resume the program operation and resuming the program operation based at least in part on issuing the internal command.

Aspect 13: The method, apparatus, or non-transitory computer-readable medium of aspect 12, where the program operation is resumed after a duration from issuing the internal command to resume the program operation.

Aspect 14: The method, apparatus, or non-transitory computer-readable medium of any of aspects 12 through 13, further including operations, features, circuitry, logic, means, or instructions, or any combination thereof for receiving a write command, where storing the one or more read commands to the one or more queues of the memory system is based at least in part on receiving the write command, and where the program operation and the resumed program operation are associated with the write command.

Aspect 15: The method, apparatus, or non-transitory computer-readable medium of any of aspects 1 through 14, where performing the one or more read operations includes operations, features, circuitry, logic, means, or instructions, or any combination thereof for performing, during a first duration, a first read operation corresponding to a first read command stored to the first queue of the one or more queues associated with a first plane of the memory system and performing, during a second duration, a second read operation corresponding to a second read command stored to a second queue of the one or more queues associated with a second plane of the memory system, where performing the first read operation during the first duration and performing the second read operation during the second duration at least partially overlap in time.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
processing circuitry associated with one or more memory devices and configured to cause the apparatus to:
store, during a program operation, one or more read commands to one or more queues of a memory system, wherein each queue of the one or more queues is associated with a respective plane of the memory system;
suspend the program operation based at least in part on a quantity of read commands stored to a first queue of the one or more queues satisfying a threshold quantity; and
perform, while the program operation is suspended, one or more read operations corresponding to the read commands stored to the one or more queues based at least in part on suspending the program operation.

2. The apparatus of claim 1, wherein the processing circuitry is further configured to cause the apparatus to:
resume the program operation after performing read operations corresponding to each of the read commands stored to the one or more queues.

3. The apparatus of claim 1, wherein the processing circuitry is further configured to cause the apparatus to:
resume the program operation after performing the one or more read operations and based at least in part on the quantity of read commands stored to the first queue of the one or more queues failing to satisfy the threshold quantity.

4. The apparatus of claim 1, wherein the processing circuitry is further configured to cause the apparatus to:
receive the one or more read commands within a threshold duration, wherein suspending the program operation is based at least in part on receiving the one or more read commands within the threshold duration.

5. The apparatus of claim 1, wherein the processing circuitry is further configured to cause the apparatus to:
receive one or more second read commands before the program operation is initiated; and
perform, before the program operation is initiated, the one or more second read commands based at least in part on receiving the one or more second read commands.

6. The apparatus of claim 1, wherein each queue of the one or more queues are associated with a first logical unit number (LUN) of the memory system.

7. The apparatus of claim 6, wherein the processing circuitry is further configured to cause the apparatus to:
group a read command from each queue of the one or more queues into a single read command; and
issue the single read command based at least in part on grouping the read command from each queue, wherein performing the one or more read operations corresponding to the read command stored to each queue is based at least in part on issuing the single read command.

8. The apparatus of claim 1, wherein performing the one or more read operations comprises the processing circuitry configured to cause the apparatus to:
perform a read operation corresponding to a read command stored to each queue of the one or more queues, wherein each read operation is associated with a different plane of the memory system.

9. The apparatus of claim 1, wherein the processing circuitry is further configured to cause the apparatus to:
receive the one or more read commands during the program operation, wherein storing the one or more read commands is based at least in part on receiving the one or more read commands.

10. The apparatus of claim 1, wherein the processing circuitry is further configured to cause the apparatus to:
issue an internal command to suspend the program operation based at least in part on the quantity of read commands stored to the first queue of the one or more queues satisfying the threshold quantity, wherein suspending the program operation is based at least in part on issuing the internal command.

11. The apparatus of claim 10, wherein the one or more read operations are performed after a duration from issuing the internal command to suspend the program operation.

12. The apparatus of claim 1, wherein the processing circuitry is further configured to cause the apparatus to:
issue an internal command to resume the program operation; and
resume the program operation based at least in part on issuing the internal command.

13. The apparatus of claim 12, wherein the program operation is resumed after a duration from issuing the internal command to resume the program operation.

14. The apparatus of claim 12, wherein the processing circuitry is further configured to cause the apparatus to:
receive a write command, wherein storing the one or more read commands to the one or more queues of the memory system is based at least in part on receiving the write command, and wherein the program operation and the resumed program operation are associated with the write command.

15. The apparatus of claim 1, wherein performing the one or more read operations comprises the processing circuitry configured to cause the apparatus to:
perform, during a first duration, a first read operation corresponding to a first read command stored to the first queue of the one or more queues associated with a first plane of the memory system; and
perform, during a second duration, a second read operation corresponding to a second read command stored to a second queue of the one or more queues associated with a second plane of the memory system, wherein performing the first read operation during the first duration and performing the second read operation during the second duration at least partially overlap in time.

16. A method, comprising:
storing, during a program operation, one or more read commands to one or more queues of a memory system, wherein each queue of the one or more queues is associated with a respective plane of the memory system;
suspending the program operation based at least in part on a quantity of read commands stored to a first queue of the one or more queues satisfying a threshold quantity; and
performing, while the program operation is suspended, one or more read operations corresponding to the read commands stored to the one or more queues based at least in part on suspending the program operation.

17. The method of claim 16, further comprising:
resuming the program operation after performing read operations corresponding to each of the read commands stored to the one or more queues.

18. The method of claim 16, further comprising:
resuming the program operation after performing the one or more read operations and based at least in part on the quantity of read commands stored to the first queue of the one or more queues failing to satisfy the threshold quantity.

19. The method of claim 16, further comprising:
receiving the one or more read commands within a threshold duration, wherein suspending the program operation is based at least in part on receiving the one or more read commands within the threshold duration.

20. The method of claim 16, further comprising:
receiving one or more second read commands before the program operation is initiated; and
performing, before the program operation is initiated, the one or more second read commands based at least in part on receiving the one or more second read commands.

21. The method of claim 16, wherein each queue of the one or more queues are associated with a first logical unit number (LUN) of the memory system.

22. The method of claim 21, further comprising:
grouping a read command from each queue of the one or more queues into a single read command; and
issuing the single read command based at least in part on grouping the read command from each queue, wherein performing the one or more read operations corresponding to the read command stored to each queue is based at least in part on issuing the single read command.

23. The method of claim 16, wherein performing the one or more read operations comprises:
performing a read operation corresponding to a read command stored to each queue of the one or more queues, wherein each read operation is associated with a different plane of the memory system.

24. The method of claim 16, further comprising:
receiving the one or more read commands during the program operation, wherein storing the one or more read commands is based at least in part on receiving the one or more read commands.

25. A non-transitory computer-readable medium storing code that comprises instructions executable by one or more processors to:
store, during a program operation, one or more read commands to one or more queues of a memory system, wherein each queue of the one or more queues is associated with a respective plane of the memory system;
suspend the program operation based at least in part on a quantity of read commands stored to a first queue of the one or more queues satisfying a threshold quantity; and
perform, while the program operation is suspended, one or more read operations corresponding to the read commands stored to the one or more queues based at least in part on suspending the program operation.
